(19) United States
(12) Patent Application Publication
(10) Pub. No.: US 2024/0320651 A1
(43) Pub. Date: Sep. 26, 2024

(54) METHOD AND APPARATUS FOR PAYMENT SERVICE

(71) Applicant: KAKAO CORP., Jeju-si (KR)

(72) Inventors: Eun Ha KIM, Seongnam-si (KR); Hyo Eun LEE, Seongnam-si (KR); Kyeong Jin KIM, Seongnam-si (KR); Ji Ho MOON, Seongnam-si (KR)

(21) Appl. No.: 18/598,986

(22) Filed: Mar. 7, 2024

(30) Foreign Application Priority Data
Mar. 20, 2023 (KR) 10-2023-0036176
Jun. 27, 2023 (KR) 10-2023-0082767

(51) Int. Cl. G06Q 20/32; G06Q 20/22; G06Q 20/34; G06Q 20/40

(52) U.S. Cl. CPC G06Q 20/3224; G06Q 20/227; G06Q 20/351; G06Q 20/409

(57) ABSTRACT

A method and apparatus for a payment service are disclosed. A method of operating a server providing a payment service includes obtaining country-related information of a terminal connected to the payment service. The country-related information of a terminal may include a country code the number of the terminal is assigned to. The method includes providing an international credit card as an option for a payment method to the terminal based on the country-related information. The method includes checking whether an account corresponding to the terminal is authenticated. The method includes determining a default value of a payment method corresponding to the account based on whether the account is authenticated.

### CROSS-REFERENCE TO RELATED APPLICATIONS

This application claims priority under 35 USC § 119(a) to Korean Patent Application No. 10-2023-0036176 filed on Mar. 20, 2023, and Korean Patent Application No. 10-2023-0082767 filed on Jun. 27, 2023, in the Korean Intellectual Property Office, the disclosures of which are incorporated by reference herein in its entirety.

### BACKGROUND

### Technical Field

The following description relates to a method and apparatus for a payment service and, more particularly, to a server providing a payment service and a terminal using the payment service.

### Description of Related Art

Financial technology, or FinTech, a compound word for finance and technology, refers to financial services and industries based on advanced information technology (IT) encompassing mobile services, bigdata, social network services (SNS), and the like. Representative examples of technology-based services that are based on IT and differentiated from existing financial services may include mobile payment, remittance, financial management, cloud funding, and app card services. Non-financial companies may also provide simple and convenient financial services by providing, directly to users, financial services such as payment and settlement using their own technologies.

### BRIEF SUMMARY

Various embodiments of the present disclosure provide a quick and easy way of setting a payment for completing a transaction. The mobile devices such as a terminal is assigned an identification number (e.g., a mobile phone number). A country code (such as, +1 for U.S. and +82 for Korea) is also associated with the mobile phone number. In the related art, when a user wanted to select a payment for completing a transaction through the user's terminal, the user was limited to a few options which was further restricted by the type of payment method associated with the country code of the terminal. Various embodiments provided herein provide a technical solution to the one or more problems in the related art and facilitates the payment experience and improves user experience.

Various embodiments of the present disclosure provide a payment service that may also be used even through a terminal abroad by allowing users using an international code to select an overseas card (also referred to herein as an international card) as a payment method.

However, various embodiments are not limited to the foregoing aspect, and there may be other technical aspects.

According to some embodiments, there is provided a method of operating a terminal using a payment service, the method including: obtaining country-related information of the terminal; setting an international card as one of payment methods based on the country-related information; and based on whether an account corresponding to the terminal is authenticated, determining a default value of a payment method corresponding to the account.

The country-related information may include a country code of the terminal, and the setting of the international card as one of the payment methods may include: when the country code is a code of a country that supports an international card payment service, setting the international card as one of the payment methods.

The determining the default value of the payment method may include checking whether the account is authenticated.

The checking of whether the account is authenticated may include: checking whether there is a history of authenticating that user information registered in the number of the terminal and input user information corresponding to the account are matched.

The account may be linked to one or more codes.

The determining of the default value of the payment method may include: when it is checked that the account is not authenticated, determining the international card to be the default value of the payment method corresponding to the account.

The determining of the default value of the payment method may include: when it is checked that the account is authenticated, determining a simple payment to be the default value of the payment method corresponding to the account.

The method may further include: receiving an input for selecting a payment method from a user; and calling an interface for authenticating the account based on whether the account is authenticated and whether the selected payment method is a payment method requiring authentication.

According to another aspect, there is provided a method of operating a server providing a payment service, the method including: obtaining country-related information of a terminal connected to the payment service; providing an international card as an option for a payment method to the terminal based on the country-related information; checking whether an account corresponding to the terminal is authenticated; and based on whether the account is authenticated, determining a default value of a payment method corresponding to the account.

The country-related information may include a country code of the terminal, and the providing of the international card as an option for the payment method to the terminal may include: when the country code is a code of a country that supports an international card payment service, providing the international card as an option for the payment method.

The determining of the default value of the payment method may include: when it is checked that the account is not authenticated, determining the international card as the default value of the payment method corresponding to the account.

The determining of the default value of the payment method may include: when it is checked that the account is authenticated, determining a simple payment as the default value of the payment method corresponding to the account.

The method may further include: receiving a payment request corresponding to the selected payment method from the terminal; and providing an interface for authenticating the account to the terminal based on whether the account is authenticated and whether the selected payment method is a payment method requiring authentication.

According to another aspect, there is provided a terminal using a payment service, the terminal including a processor. The processor may be configured to: obtain country-related information of the terminal; set (or expose) an international card as one of payment methods based on the country-related information; and based on whether an account corresponding to the terminal is authenticated, determine a default value of a payment method corresponding to the account.

For the determining of the default value of the payment method, the processor may be configured to: when it is checked that the account is not authenticated, determine the international card as the default value of the payment method corresponding to the account.

For the determining of the default value of the payment method, the processor may be configured to: when it is checked that the account is authenticated, determine a simple payment as the default value of the payment method corresponding to the account.

The processor may be configured to: receive an input from a user selecting a payment method; and call an interface for authenticating the account based on whether the account is authenticated and whether the selected payment method is a payment method requiring authentication.

According to another aspect, there is provided a server providing a payment service, the server including a processor. The processor may be configured to: obtain country-related information of a terminal connected to the payment service; provide an international card as an option for a payment method to the terminal, based on the country-related information; check whether an account corresponding to the terminal is authenticated; and determine a default value of a payment method corresponding to the account, based on whether the account is authenticated.

For the determining of the default value of the payment method, the processor may be configured to: when it is checked that the account is not authenticated, determine the international card as the default value of the payment method corresponding to the account; and when it is checked that the account is authenticated, determine a simple payment as the default value of the payment method corresponding to the account.

### BRIEF DESCRIPTION OF THE SEVERAL VIEWS OF THE DRAWINGS

The above and other features of certain embodiments of the present disclosure will be more apparent from the following detailed description, taken in conjunction with the accompanying drawings, in which:

FIG. 1 is a diagram illustrating a system for payment according to an embodiment;

FIG. 2 is a flowchart illustrating a method of operating a terminal using a payment service according to an embodiment;

FIG. 3 is a diagram illustrating an example of an interface screen of a payment-related application (app) provided to a terminal using an international code according to an embodiment;

FIGS. 4A and 4B are diagrams illustrating examples of an interface screen of a payment-related app provided to a terminal of an unauthenticated account that uses an international code according to an embodiment;

FIGS. 5A and 5B are diagrams illustrating examples of an interface screen of a payment-related app provided to a terminal of an authenticated account according to an embodiment;

FIG. 6 is a diagram illustrating an interface for authentication provided when a payment method requiring account authentication is selected, according to an embodiment;

FIG. 7 is a diagram illustrating an example of an interface screen in which payment methods that require account authentication and payment methods that do not require account authentication are displayed separately, according to an embodiment;

FIG. 8 is a flowchart illustrating a method of operating a server providing a payment service according to an embodiment; and

FIG. 9 is a diagram illustrating an example of a hardware configuration of a system for a payment service according to an embodiment.

### DETAILED DESCRIPTION

The following detailed structural or functional description is provided only for the purpose of providing examples, and various alterations and modifications may be made to the examples. Here, the examples are not construed as limited to the disclosure and should be understood to include all changes, equivalents, and replacements within the idea and the technical scope of the disclosure.

Although terms, such as first, second, and the like are used to describe various components, the components are not limited to the terms. These terms should be used only to distinguish one component from another component. For example, a first component may be referred to as a second component, and similarly the second component may also be referred to as the first component.

It should be noted that, if one component is described as “connected,” “coupled,” or “joined” to another component, a third component may be “connected,” “coupled,” and “joined” between the first and second components, although the first component may be directly connected, coupled, or joined to the second component.

The singular forms “a,” “an,” and “the” are intended to include the plural forms as well, unless the context clearly indicates otherwise. It will be further understood that the terms “comprises/comprising” and/or “includes/including,” when used herein, specify the presence of stated features, integers, steps, operations, elements, and/or components, but do not preclude the presence or addition of one or more other features, integers, steps, operations, elements, components and/or groups thereof.

Unless otherwise defined, all terms, including technical and scientific terms, used herein have the same meaning as commonly understood by one of ordinary skill in the art to which the present disclosure pertains. Terms, such as those defined in commonly used dictionaries, are to be interpreted as having a meaning that is consistent with their meaning in the context of the relevant art and the disclosure of the present application and is not to be interpreted in an idealized or overly formal sense unless expressly so defined herein.

Hereinafter, embodiments will be described in detail with reference to the accompanying drawings. When describing the embodiments with reference to the accompanying drawings, like reference numerals refer to like components and a repeated description related thereto will be omitted.

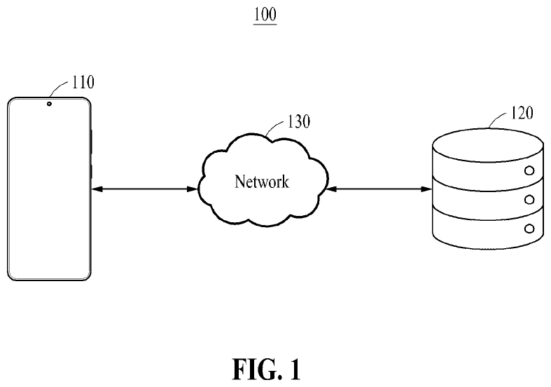

FIG. 1 is a diagram illustrating a system for payment according to an embodiment.

Referring to FIG. 1, according to an embodiment, a system 100 for payment may include a terminal 110, a server 120, and a network 130. The hardware configurations of the server 120 and the terminal 110 will be described in detail below.

According to an embodiment, the server 120 may include a server that provides a payment service. The payment service may refer to a service that supports payment for products and/or services sold on social commerce platforms through the network 130 such as wireless Internet or wireless communication networks using various payment methods such as a credit card (or simply “card”). For example, the payment service may provide at least one payment function including, for example, a simple payment function by which payment may be made using registered card or account information, a payment function using points (such as credit card points, or any other type of rewards), and a payment function performed by entering card or account information. The term “simple payment” or “simple payment function” broadly refers to and includes various ways of quickly and easily processing the payment, which may include facilitating the payment process of the user by not requiring the user to manually insert payment related information every time for completing a transaction.

The simple payment function refers to a payment function performed only through a simple and quick procedure supported by the payment service. For example, the simple payment function may include, but not limited to, a point-recharge type simple payment that involves charging, in a simple payment service account, money from a card or bank account under the own name of an authenticated user and making a payment with the charged money, and a bank account and card payment-related type simple payment function of a mobile debit card type that involves making a payment with money from a bank account only when the payment is to be made by connecting in advance a debit card or bank account under the own name of an authenticated user.

According to an embodiment, the server 120 may include a server that provides a FinTech service. The Fintech service, which is a financial service using information technology (IT), may refer to a service related to mobile banking and payments such as deposit, payment, and remittance provided through the network 130 such as wireless Internet or wireless communication networks.

The server 120 may be linked to an application (hereinafter referred to as an “app”) related to a payment service (hereinafter simply referred to as a “payment service-related app”) executed on the terminal 110 for user interfaces (UIs), functions, operations, services, and the like, or to a payment service-related website. The payment service-related app may also be referred to herein as a “payment app,” and the payment service-related web may also be referred to herein as a “payment web.”

The terminal 110 may include, for example, a personal computer (PC), a netbook, a laptop, a personal digital assistant or appliance (PDA), a smartphone, a wearable device, and other various devices that perform similar functions.

The terminal 110 may be driven by the payment app or the payment web provided by the server 120. The user may execute the payment app or the payment web on the terminal 110 to use the payment service provided by the server 120. The user may create a user account by subscribing to the payment service through the payment app or the payment web. The user may use the payment service through the terminal 110 of the user account subscribed to the payment service. The terminal 110 of the user account subscribed to the payment service may refer to a terminal logged in with the user account subscribed to the payment service.

According to an embodiment, the server 120 may include a server that provides an instant messaging service linked to the payment service through the network 130. The instant messaging service may include, for example, a service that allows multiple users to chat in real time by transmitting instant messages such as text messages, voice messages, media files, and the like in real time through the network 130 such as wireless Internet or wireless communication networks, and services related thereto.

According to an embodiment, the server 120 may be linked to the instant messaging service or an instant messaging server. The server 120 may provide the payment service linked to the instant messaging service and may also provide the payment service linked to the instant messaging server. For example, information requesting payment from the payment service and information indicating that a payment has been completed may be transmitted in the form of a message through a chat room provided by the instant messaging service. For example, the user may access the payment service through an instant messenger. The user may use the payment service using a user account subscribed to the instant messaging service. Alternatively, the user may use the instant messaging service using the user account subscribed to the payment service.

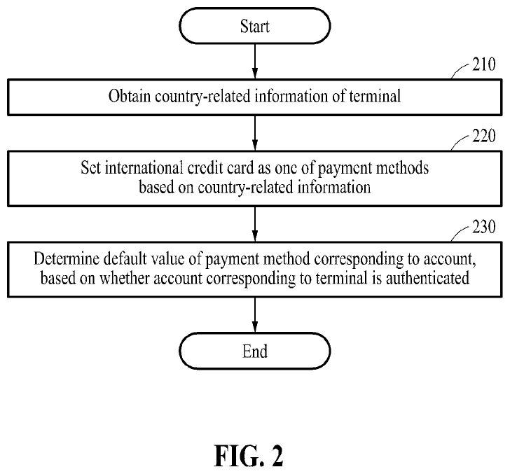

FIG. 2 is a flowchart illustrating a method of operating a terminal using a payment service according to an embodiment.

According to an embodiment, a terminal may be the terminal 110 described above with reference to FIG. 1, and a payment service may be a service provided by the server 120. As described above, the terminal may use the payment service provided by the server 120 by executing a payment app or a payment web.

Referring to FIG. 2, according to an embodiment, a method of operating the terminal using the payment service (hereinafter simply referred to as a “method”) may include operation 210 of obtaining country-related information of the terminal. The country-related information of the terminal may refer to information indicating a country in which the terminal is located or a country in which the terminal is used. The country-related information of the terminal may include but not limited to, for example, a country code of the terminal. The country code of the terminal may be obtained from a mobile phone number of the terminal. Generally, the mobile phone number of the terminal includes the country code. The country code may be used when a user makes a call with a mobile terminal located in one country to a mobile terminal located in another country. According to the International Telecommunication Union (ITU) Telecommunication Standardization Sector (ITU-T) standard, the country code is a number consisting of a sign “+” and at least one digit or a maximum of three digits. For example, a country code of South Korea is +82, a country code of Japan is +81, and a country code of the United States and Canada is +1.

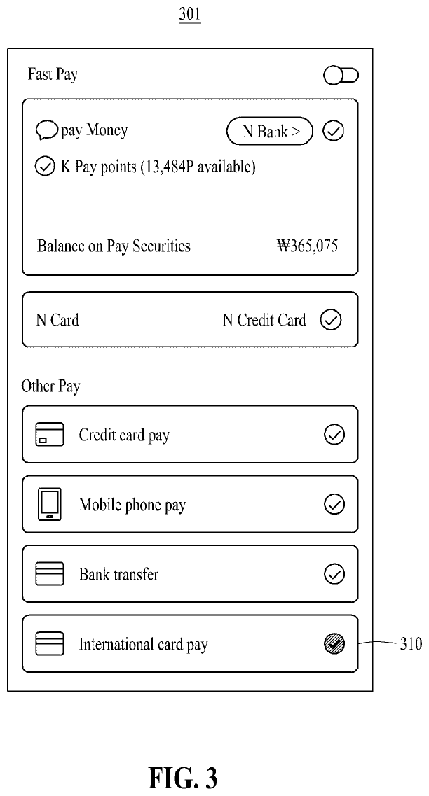

According to an embodiment, the method may include operation of 220 of setting an overseas credit card (also referred to herein as an “international credit card” or simply an “international card”) as one of payment methods based on the country-related information. The country code may be used to determine whether the number of the terminal corresponds to a domestic code or an international code. When it is determined that the terminal uses the international code, an international card may be set as one of the payment methods. For example, referring to an interface screen 301 of a payment app shown in FIG. 3, an item 310 for international card payment may be added to a list of payment methods from which the user may select. The user may select one from the list of payment methods and request the server for a payment using the selected payment method. In some embodiments, the process of setting an international card based on the international code used by the terminal may be automatically performed in order to facilitate the simple payment method.

According to an embodiment, operation 220 of setting an international card as one of the payment methods may include an operation of setting the international card as one of the payment methods when the country code is a code of a country that supports an overseas card payment service (also referred to herein as an “international card payment service”). That is, for example, when the country code of the terminal is a code of a country that supports the international card payment service in the payment app among countries other than the domestic country itself, the international card may be set as one of the payment methods. For example, if the country code of the terminal is +82 (Korea), in a case in which the payment app supports an international card payment service of the United States and Japan (namely, when the country code of the terminal is +1 or +81, which is the country code of the United States or Japan, respectively) the international card may be set as one of the payment methods. In some embodiments, the process of setting the international card as one of the payment methods when the country code is a code of a country that supports an overseas card payment service may be automatically performed at the terminal in order to facilitate the simple payment method.

According to an embodiment, the method may include operation 230 of determining, based on whether an account corresponding to the terminal is authenticated, a default value of a payment method corresponding to the account.

According to an embodiment, operation 230 may include an operation of checking whether the account corresponding to the terminal is authenticated. The account corresponding to the terminal may refer to an account logged in through the terminal.

According to an embodiment, the operation of checking whether the account corresponding to the terminal is authenticated may include an operation of checking whether there is a history of authenticating that user information registered in the number of the terminal matches input user information corresponding to the account. When the account has a history of being authenticated, it may be determined that the account is authenticated.

The account may be linked to one or more codes (e.g., country codes such as domestic code, international code, etc.). For example, when the user logs in to an app using a terminal using a domestic code, the domestic code may be linked to an account used for the logging. In this example, when the user logs in to the account using a terminal using an international code to use the app, the international code may be linked to the account. When the international code is linked to the account, link information of the domestic code may also be maintained instead of being replaced or removed. The account may be determined to be authenticated when authentication is performed on at least one of the linked codes.

The default value of a payment method may be a value indicating a payment method set before a user input for selecting the payment method is received. For example, when payment methods available to the user include a first payment method and a second payment method, and the default value is set to be the first payment method, the payment method may be set as the first payment method before an input for selecting another payment method is received from the user.

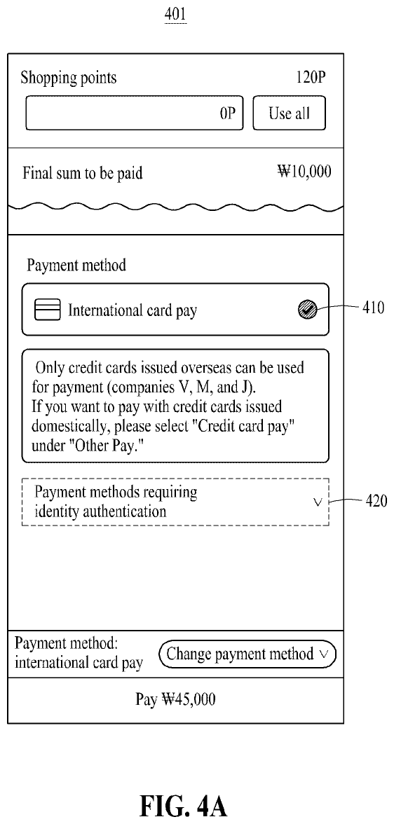

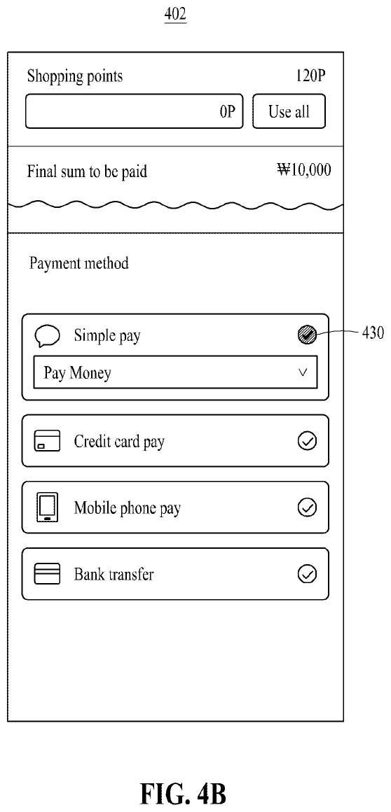

According to an embodiment, operation 230 of determining the default value of the payment method may include an operation of determining the international card as the default value of the payment method when it is checked that the account is not authenticated. For example, referring to an interface screen 401 of a payment app shown in FIG. 4A, when it is checked that an account is not unauthenticated and a user input for selecting a payment method is not received from the user, an item 410 for international card payment may already be selected as a payment method. In this example, items for other payment method and the item 410 for international card payment may be displayed separately. For example, the items for other payment methods, excluding the item 410 for international card payment, may be grouped and displayed in a list 420 of payment methods requiring identity authentication. By an input that selects the list 420 of payment methods requiring identity authentication, the payment methods requiring identity authentication, such as, for example, simple payment, mobile phone payment, and bank transfer, may be displayed. When the account is not authenticated, selecting, as the payment method, an item included in the list 420 of payment methods requiring identity authentication may be restricted. Alternatively, when an item included in the list 420 of payment methods requiring identity authentication is selected as the payment method, identity authentication may be requested, and the item may be selected as the payment method after the identity authentication is completed.

For example, referring to an interface screen 402 of a payment app shown in FIG. 4B, when a product for which payment is to be made is a product (e.g., exchange voucher, product to be delivered through an agent, etc.) that does not support international card payment, an item for international card payment may not be exposed to a terminal of an unauthenticated user account. For example, when a product for which payment is to be made is a product that does not support international card payment, an item for simple payment may be determined as a default value of a payment method.

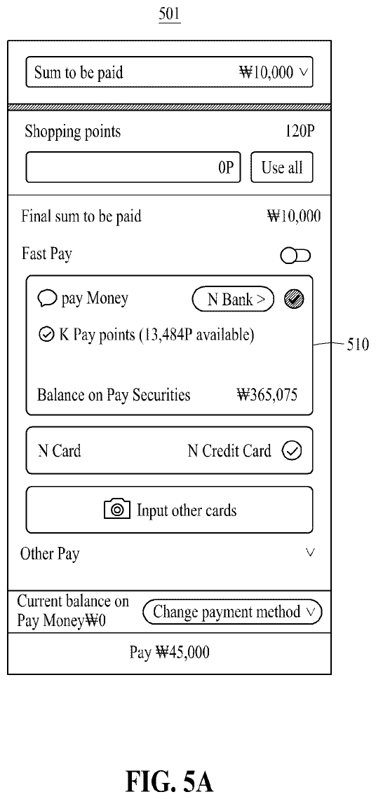

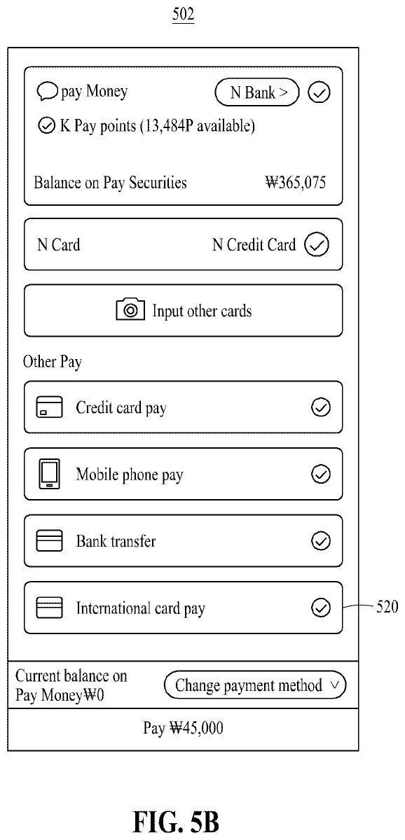

According to an embodiment, operation 230 may include an operation of determining a simple payment as the default value of the payment method when it is checked that the account is authenticated. For example, referring to an interface screen 501 of a payment app shown in FIG. 5A, when an account is authenticated but a user input for selecting a payment method is not received from a user, an item 510 for first simple payment may already be selected as a payment method. In this case, when a user input for selecting an item for another payment method that is not the item 510 for first simple payment is received, a payment method corresponding to the selected item may be selected as the payment method.

Referring to an interface screen 502 of a payment app shown in FIG. 5B, when a country code of an authenticated account is an international code for a foreign country, an item 520 for international card payment may be exposed as a payment method. In this case, when a user input for selecting the item 520 for international card payment is received, a payment method may be changed from the simple payment to an international card. On the other hand, when a country code of an authenticated account is not an international code for a foreign country, an item 520 for international card payment would not be exposed as an option for a payment method.

According to an embodiment, the method of operating the terminal using the payment service, which is described above, may include an operation of receiving an input for selecting a payment method, and calling an interface for account authentication based on whether the account is authenticated and whether the selected payment method is a payment method requiring authentication.

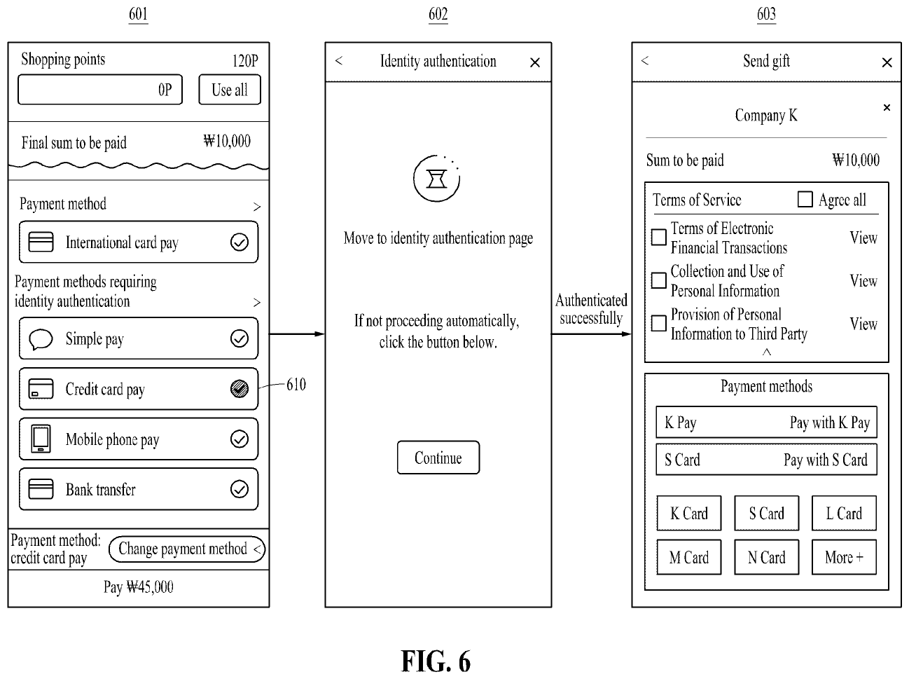

For example, when an input for selecting a payment method requiring account authentication is received from a user of an unauthenticated account, an interface for authentication may be called. In this example, referring to FIG. 6, when an input for selecting, as a payment method, an item 610 for credit card payment that requires account authentication from the user of the unauthenticated account is received through an interface screen 601 for selecting a payment method, an interface screen 602 notifying that an interface for authentication (also referred to herein as an “authentication interface”) is called may be displayed.

Once the account is authenticated through the authentication interface, a payment may be made using the selected payment method. For example, referring to FIG. 6, when the account is authenticated through the authentication interface, an interface screen 603 for proceeding with the selected credit card payment may be displayed.

When the account authentication fails, selecting again a payment method may be requested. For example, referring to FIG. 6, when the account authentication fails, the interface screen 601 for selecting a payment method may be displayed again. According to an embodiment, when the account authentication fails, a message guiding the user to select a payment method that does not require authentication may be displayed through an interface.

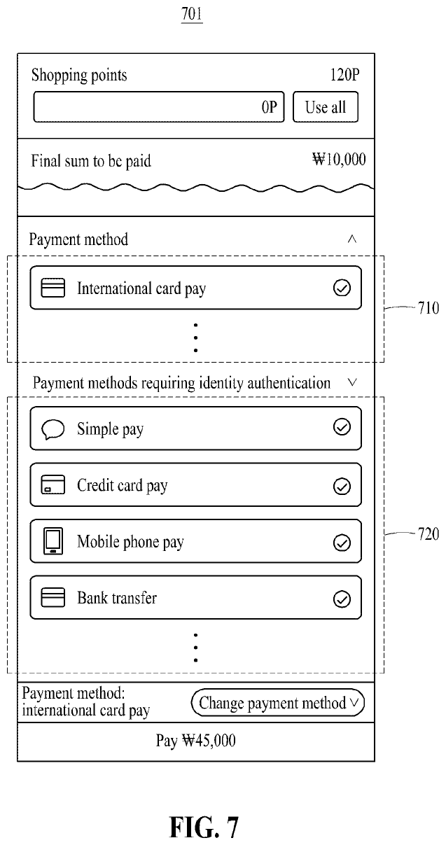

According to an embodiment, an interface for selecting a payment method may display a payment method that requires account authentication and a payment method that does not require account authentication, separately. For example, referring to an interface screen 701 of a payment app shown in FIG. 7, based on whether a payment method requires account authentication, a list 710 of payment methods that require account authentication and a list 720 of payment methods that do not require account authentication may be displayed separately.

According to an embodiment, an item for a payment method included in a list of payment methods to be exposed to a user of a terminal may be determined based on at least one of country-related information of the terminal or whether an account corresponding to the terminal is authenticated.

For example, based on the country-related information of the terminal, items for payment methods available in a country in which the terminal is used may be included in the list of payment methods to be exposed to users of the terminal. In this case, based on whether the country in which the terminal is used is a home country or a foreign country, the number of items of payment methods to be included in the list of payment methods may vary, and the types of payment methods to be included in the list of payment methods may also vary.

For example, when the account corresponding to the terminal is authenticated, items for payment methods available to the authenticated account may be included in the list of payment methods to be exposed to the user of the terminal. In this example, when the account corresponding to the terminal is not authenticated, items for payment methods whose use is restricted to the unauthenticated account may be excluded from the list of payment methods to be exposed to the user.

According to an embodiment, the order of items for payment methods included in a list of payment methods may be determined based on at least one of country-related information of a terminal or whether an account corresponding to the terminal is authenticated. For example, the order of items for payment methods included in the list of payment methods may be determined such that an item for a payment method determined as a default value is located at the top of the list of payment methods. The order of items for payment methods included in the list of payment methods may be determined by settings by the user.

According to an embodiment, the size at which items for payment methods are displayed may be determined based on a position on the list of payment methods. For example, an item for a payment method located at the top of the list of payment methods may be displayed larger than other items for payment methods.

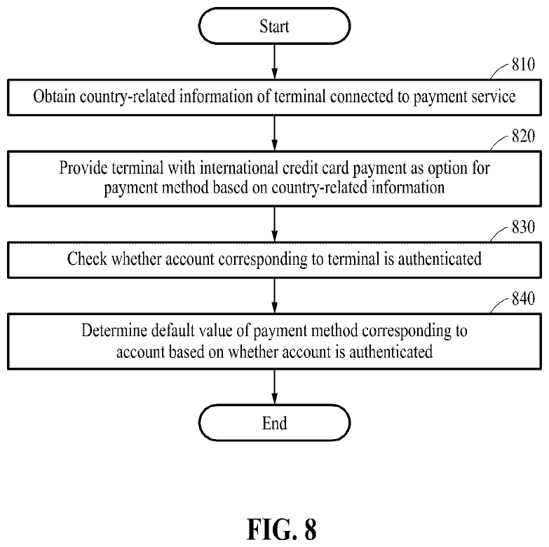

FIG. 8 is a flowchart illustrating a method of operating a server providing a payment service according to an embodiment.

According to an embodiment, a server and a terminal may correspond, respectively, to the server 120 and the terminal 110 described above with reference to FIG. 1, and a payment service may correspond to a service provided by the server 120. As described above, the terminal may execute a payment app or a payment web to use or access the payment service provided by the server 120.

Referring to FIG. 8, according to an embodiment, a method of operating the server providing the payment service may include operation 810 of obtaining country-related information of the terminal connected to the payment service; operation 820 of providing a terminal with an international card as an option for a payment method based on the country-related information; operation 830 of checking whether an account corresponding to the terminal is authenticated; and operation 840 of determining a default value of a payment method corresponding to the account based on whether the account is authenticated.

According to an embodiment, the country-related information may include country information of the terminal. A country code of the terminal may be obtained from a mobile phone number of the terminal. The country code may be transmitted from the terminal to the server.

According to an embodiment, whether the number of the terminal corresponds to a domestic code or an international code may be determined based on the country code of the terminal. When it is determined that the terminal uses the international code, the server may provide the terminal with an international card as an option for the payment method through the payment app or the payment web. That is, the international card may be added as an option for the payment method that the user may select.

According to an embodiment, operation 820 may include an operation of providing the international card as an option for a payment method when the country code is a code of a country that supports an international card payment service. When the terminal uses an international code and a foreign country corresponding to the international code is the code of the country that supports the international card payment service, the server may provide the terminal with the international card as an option for the payment method through the payment app or the payment web.

According to an embodiment, the server may check whether the account corresponding to the terminal is authenticated. The account corresponding to the terminal may refer to an account logged in through the terminal.

According to an embodiment, operation 830 of checking whether the account corresponding to the terminal is authenticated may include an operation of checking whether there is a history of authenticating (also referred to herein as an “authentication history”) that user information registered in the number of the terminal matches input user information corresponding to the account. For example, such a history of the account about being authenticated, or the authentication history, may be stored in a memory in the server or in an external memory accessible from the server. The server may check whether there is a stored authentication history of the account and confirm the account as an authenticated account when the authentication history of the account is present.

According to an embodiment, operation 840 may be the same as operation 230, except that the subjects of performing operations 840 and 230 are different. For example, operation 840 of determining the default value of the payment method may include an operation of determining the international card as the default value of the payment method when it is checked that the account is not authenticated. For example, operation 840 of determining the default value of the payment method may include an operation of determining a simple payment as the default value of the payment method when it is checked that the account is authenticated.

When the default value of the payment method is determined by the server, the server may provide the terminal with an interface for selecting a payment method in which the payment method of the default value has already been selected. The terminal may display one or more payment methods as selectable options for a payment method. The terminal may display that the default value of the payment method is selected as the payment method.

According to an embodiment, the method of operating the server may further include an operation of receiving a payment request corresponding to the selected payment method from the terminal; and based on whether the account is authenticated and whether the selected payment method is a payment method requiring authentication, providing the terminal with an interface for authenticating the account. For example, when a payment request corresponding to a payment method requiring account authentication is received from a terminal with an unauthenticated account, the server may provide the terminal with an interface for authentication.

Once the account is authenticated through the interface for authentication, the server may proceed with a payment using the selected payment method. When the account authentication fails, the server may request that a payment method be selected again through the interface of the terminal.

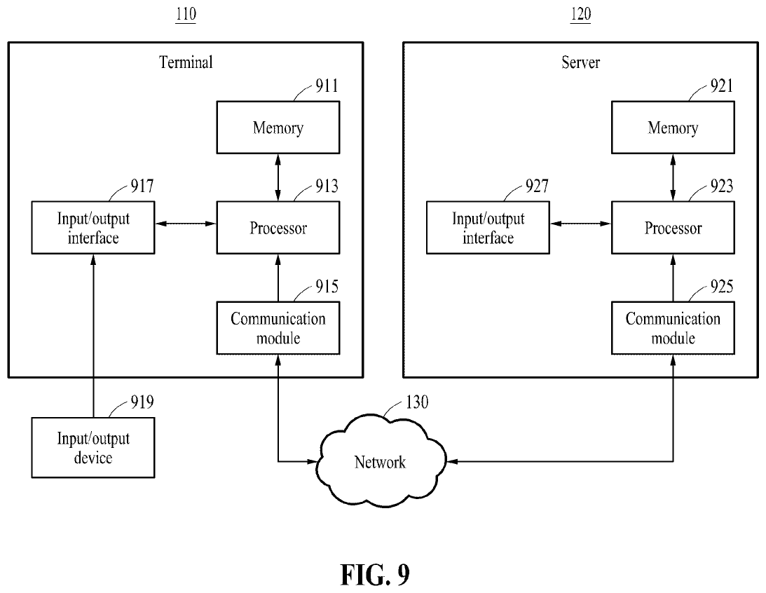

FIG. 9 is a diagram illustrating an example of a hardware configuration of a system for a payment service according to an embodiment.

Referring to FIG. 9, according to an embodiment, a system (e.g., the system 100 of FIG. 1) may include a terminal 110 and a server 120 connected through a network 130.

According to an embodiment, the terminal 110 may be a mobile terminal implemented as a computer device. For example, the terminal 110 may communicate with the server 120 and/or other electronic devices through the network 130 using a wireless or wired communication method.

According to an embodiment, the server 120 may be implemented as a computer device or a plurality of computer devices that communicate with the terminal 110 and/or other servers through the network 130 to provide commands, codes, files, content, services, and the like. The communication method may include, as non-limiting examples, a communication method using a communication network (e.g., mobile communication networks, wired Internet, wireless Internet, broadcasting networks, etc.) that may be included in the network 130 and a short-range wireless communication method between devices. The network 130 may include, for example, at least one of a personal area network (PAN), a local area network (LAN), a campus area network (CAN), a metropolitan area network (MAN), a wide area network (WAN), a broadband network (BBN), or the Internet.

According to an embodiment, the server 120 may provide a file for installing an application (or app) to the terminal 110 connected through the network 130. In this case, the terminal 110 may install the application (e.g., a payment app, a payment web, or an instant messenger) using the file provided by the server 120. In addition, the terminal 110 may connect to the server 120 under the control of an operating system (OS) and at least one program (e.g., a browser or the installed application) included in the terminal 110 and receive services or content provided by the server 120. For example, when the terminal 110 transmits a service request message to the server 120 through the network 130 under the control of the application, the server 120 may transmit a code corresponding to the service request message to the terminal 110, and the terminal 110 may then provide content to a user by configuring and displaying a screen according to the code under the control of the application.

According to an embodiment, the terminal 110 and the server 120 may each include a memory (e.g., 911 and 921), a processor (e.g., 913 and 923), a communication module (e.g., 915 and 925), and an input/output interface (e.g., 917 and 927).

According to an embodiment, the processor (913 and 923) may perform at least one of the operations described above with reference to FIGS. 1 to 8. For example, the processor 913 may perform at least one of the operations performed in the terminal 110 using the payment service described above with reference to FIGS. 1 to 7, and the processor 923 may perform at least one of the operations for the payment service described above with reference to FIG. 8. The processor (913 and 923) may be configured to process instructions of a computer program by performing basic arithmetic, logic, and input/output operations. The instructions may be provided to the processor (913 and 923) by the memory (911 and 921) or the communication module (915 and 925).

The memory (911 and 921) may be a computer-readable recording medium, which may include a volatile memory or a non-volatile memory. According to an embodiment, the memory (911 and 921) may store information for executing the payment app or the payment web described above with reference to FIGS. 1 to 7. For example, the memory 921 may store user account information and chat room information of a user subscribed to a payment service.

According to an embodiment, the memory 911 may include a code for the payment app or the payment web that is installed and run on the terminal 110 using the file provided by the server 120 through the network 130.

According to an embodiment, the memory 921 may store a program in which the operations for the payment service described above with reference to FIGS. 1 to 7 are implemented.

According to an embodiment, the communication module (915 and 525) may provide a function for the terminal 110 and the server 120 to communicate with each other through the network 130 and a function for them to communicate with other electronic devices or other servers.

For example, a request generated by the processor 913 of the terminal 110 according to a program code for a payment app or payment web stored in a recording device such as the memory 911 may be transmitted to the server 120 through the network 130 under the control of the communication module 915.

For example, control signals, commands, content, files, and the like provided under the control of the processor 923 of the server 120 may be received by the terminal 110 through the communication module 915 of the terminal 110 by passing through the communication module 925 and the network 130.

The input/output interface (917 and 927) may be a means for interfacing with an input/output device 919. For example, an input device may include a device such as a keyboard or a mouse, and an output device may include a device such as a display for displaying a communication session of an application. For another example, the input/output interface 917 may be a means for interfacing with a device (e.g., a touchscreen) in which input and output functions are integrated. For example, when processing a command of a computer program loaded on the memory 911, the processor 913 of the terminal 110 may display a service screen or content constructed using data provided by the server 120 on a display through the input/output interface 917. An input received from the user through the input/output device 919 may be provided in a form that may be processed by the processor 913 of the terminal 110 through the input/output interface 917.

According to an embodiment, the terminal 110 and the server 120 may include other components not shown in FIG. 9. For example, the terminal 110 may be implemented to include at least a portion of the input/output device 919 or may further include other components such as a transceiver, a global positioning system (GPS) module, a camera, various sensors, a database (DB), and the like.

The embodiments described herein may be implemented using hardware components, software components and/or combinations thereof. A processing device may be implemented using one or more general-purpose or special purpose computers, such as, for example, a processor, a controller, an arithmetic logic unit (ALU), a digital signal processor, a microcomputer, a field programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such as, parallel processors.

The software may include a computer program, a piece of code, an instruction, or some combination thereof, to independently or collectively instruct or configure the processing device to operate as desired. The software and/or data may be embodied permanently or temporarily in any type of machine, component, physical or virtual equipment, computer storage medium or device, or in a propagated signal wave capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described examples may be recorded in non-transitory computer-readable media including program instructions to implement various operations of the above-described examples. The media may also include, alone or in combination with the program instructions, data files, data structures, and the like. The program instructions recorded on the media may be those specially designed and constructed for the purposes of examples, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher-level code that may be executed by the computer using an interpreter.

The above-described hardware devices may be configured to act as one or more software modules in order to perform the operations of the above-described examples, or vice versa.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method of operating a terminal using a payment service, the method comprising:
obtaining country-related information of the terminal;
setting an international credit card as one of payment methods based on the country-related information; and
based on whether an account corresponding to the terminal is authenticated, determining a default value of a payment method corresponding to the account.

2. The method of claim 1, wherein the country-related information comprises a country code of the terminal,
wherein the setting of the international credit card as one of the payment methods comprises:
based on the country code being a code of a country that supports an international credit card payment service, setting the international credit card as one of the payment methods.

3. The method of claim 1, wherein the determining the default value of the payment method comprises:
checking whether the account is authenticated.

4. The method of claim 3, wherein the checking of whether the account is authenticated comprises:
checking whether there is a history of authenticating that user information registered in the number of the terminal and input user information corresponding to the account are matched.

5. The method of claim 1, wherein the account is linked to one or more codes.

6. The method of claim 1, wherein the determining of the default value of the payment method comprises:
based on checking that the account is not authenticated, determining the international credit card to be the default value of the payment method corresponding to the account.

7. The method of claim 1, wherein the determining of the default value of the payment method comprises:
based on checking that the account is authenticated, determining a simple payment to be the default value of the payment method corresponding to the account.

8. The method of claim 1, further comprising:
receiving an input for selecting a payment method from a user; and
calling an interface for authenticating the account based on whether the account is authenticated and whether the selected payment method is a payment method requiring authentication.

9. A method of operating a server providing a payment service, the method comprising:
obtaining country-related information of a terminal connected to the payment service;
providing an international credit card as an option for a payment method to the terminal based on the country-related information;
checking whether an account corresponding to the terminal is authenticated; and
based on whether the account is authenticated, determining a default value of a payment method corresponding to the account.

10. The method of claim 9, wherein the country-related information comprises a country code of the terminal,
wherein the providing of the international credit card as an option for the payment method to the terminal comprises:
based on the country code being a code of a country that supports an international credit card payment service, providing the international credit card as an option for the payment method.

11. The method of claim 9, wherein the determining of the default value of the payment method comprises:
based on checking that the account is not authenticated, determining the international credit card as the default value of the payment method corresponding to the account.

12. The method of claim 9, wherein the determining of the default value of the payment method comprises:
based on checking that the account is authenticated, determining a simple payment as the default value of the payment method corresponding to the account.

13. The method of claim 9, further comprising:
receiving a payment request corresponding to the selected payment method from the terminal; and
providing an interface for authenticating the account to the terminal based on whether the account is authenticated and whether the selected payment method is a payment method requiring authentication.

14. A non-transitory computer-readable storage medium storing instructions that, when executed by a processor, cause the processor to perform the method of claim 1.

15. A terminal using a payment service, comprising:
one or more processors configured to:
obtain country-related information of the terminal;
set an international credit card as one of payment methods based on the country-related information; and
based on whether an account corresponding to the terminal is authenticated, determine a default value of a payment method corresponding to the account.

16. The terminal of claim 15, wherein, for the determining of the default value of the payment method, the one or more processors are configured to:
based on checking that the account is not authenticated, determine the international credit card as the default value of the payment method corresponding to the account.

17. The terminal of claim 15, wherein, for the determining of the default value of the payment method, the one or more processors are configured to:
based on checking that the account is authenticated, determine a simple payment as the default value of the payment method corresponding to the account.

18. The terminal of claim 15, wherein the one or more processors are configured to:
receive an input from a user selecting a payment method; and
call an interface for authenticating the account based on whether the account is authenticated and whether the selected payment method is a payment method requiring authentication.

19. A server providing a payment service, comprising:
one or more processors configured to:
obtain country-related information of a terminal connected to the payment service;
provide an international credit card as an option for a payment method to the terminal, based on the country-related information;
check whether an account corresponding to the terminal is authenticated; and
determine a default value of a payment method corresponding to the account, based on whether the account is authenticated.

20. The server of claim 19, wherein, for the determining of the default value of the payment method, the one or more processors are configured to:
based on checking that the account is not authenticated, determine the international credit card as the default value of the payment method corresponding to the account; or
based on checking that the account is authenticated, determine a simple payment as the default value of the payment method corresponding to the account.
